(19) United States
(12) Patent Application Publication
(10) Pub. No.: US 2019/0208400 A1
(43) Pub. Date: Jul. 4, 2019

(54) MOVING OBJECT COMMUNICATION SYSTEM, BASE STATION DEVICE, VEHICLE, TERMINAL DEVICE, COMMUNICATION METHOD, AND PROGRAM

(71) Applicant: SHARP KABUSHIKI KAISHA, Osaka (JP)

(72) Inventors: SHIGETO SUZUKI, Sakai City (JP); KENNICHI IIJIMA, Sakai City (JP); MAKOTO YAMAMOTO, Sakai City (JP)

(21) Appl. No.: 16/232,961

(22) Filed: Dec. 26, 2018

(30) Foreign Application Priority Data
Jan. 4, 2018 (JP) 2018-000282

(51) Int. Cl. H04W 8/08; H04W 64/00

(52) U.S. Cl. CPC H04W 8/08; H04W 84/005; H04W 64/003

(57) ABSTRACT

A terminal device; a base station device; an area detection unit configured to detect a position registration area to which the base station device belongs; and a management unit configured to, in a case where the area detection unit detects a change in the position registration area to which the base station device belongs, associate information for specifying a position registration area after change with information for specifying a terminal device connected to the base station device are included.

### BACKGROUND OF THE INVENTION

### Field of the Invention

An aspect of the present invention relates to a moving object communication system, a base station device, a vehicle, a terminal device, a communication method, and a program.

### Description of Related Art

Hitherto, in mobile communication systems, a technique for managing the approximate position of a moving terminal device has become known. A mobile communication system disclosed in, for example, Patent Document 1 includes a position registration processing device that performs a position registration process on a terminal device. The position registration processing device does not execute the position registration process in a case where a request for position registration is accepted from the terminal device, and executes the position registration process on the terminal device in accordance with the acceptance of a request for position registration transmitted from a base station device in a case where the terminal device is located in a position registration area.

### PATENT DOCUMENT

[Patent Document 1] Japanese Unexamined Patent Application, First Publication No. 2013-157859

### SUMMARY OF THE INVENTION

However, in a case where a base station device is mounted on a vehicle such as a train or a bus, the base station device is assumed to move across a position registration area while maintaining connection with a terminal device. In a case where the base station device moves across a position registration area while continuing connection with a terminal device, a position registration area corresponding to a terminal device registered with a position registration processing device and a position registration area in which a terminal device is present in reality may be different from each other. However, in the position registration process disclosed in Patent Document 1, in a case where the base station device and the terminal device move across a position registration area, a position registration area in which the base station device and the terminal device are present in reality and a position registration area registered with the position registration processing device may be different from each other.

The present invention was contrived in view of the above problem, and an object thereof is to provide a moving object communication system, a base station device, a vehicle, a terminal device, a communication method, and a program which make it possible to shorten a period in which position registration areas are different from each other in a case where a base station device and a terminal device move across position registration areas.

(1) To solve the above-described problem, a moving object communication system according to one aspect of the present invention includes: a terminal device; a base station device; an area detection unit configured to detect a position registration area to which the base station device belongs; and a management unit configured to, in a case where the area detection unit detects a change in the position registration area to which the base station device belongs, associate information for specifying a position registration area after change with information for specifying a terminal device connected to the base station device.

(2) The moving object communication system according to one aspect of the present invention may further include: a control unit configured to request the management unit to associate information for specifying a position registration area after change with information for specifying a terminal device connected to the base station device in a case where a request based on the detection of a change in the position registration area to which the base station device belongs by the area detection unit is accepted.

(3) To solve the above-described problem, a base station device according to one aspect of the present invention includes: a communication unit configured to communicate with a terminal device; an area information acquisition unit configured to acquire information relating to a position registration area to which a host device belongs; a network communication unit configured to communicate with a base station control device that corresponds to the position registration area; and a control unit, wherein in a case where a change in the position registration area to which the host device belongs is detected based on the information acquired by the area information acquisition unit, the control unit is configured to transmit a request for associating a terminal device connected to the host device with a position registration area after change through the network communication unit.

(4) In the base station device according to one aspect of the present invention, the control unit may be configured to transmit the request to the base station control device corresponding to a position registration area after change.

(5) In the base station device according to one aspect of the present invention, the control unit may be configured to transmit the request to the base station control device corresponding to a position registration area before change.

(6) In the base station device according to one aspect of the present invention, the control unit may be configured to transmit a request for association of information for specifying a position registration area after change with information for specifying a terminal device connected to the host device from the base station control device corresponding to a position registration area before change to the base station control device corresponding to a position registration area after change.

(7) To solve the above-described problem, a base station device according to one aspect of the present invention includes: a communication unit configured to communicate with a terminal device; an area information acquisition unit configured to acquire information relating to a position registration area to which a host device belongs; and a control unit, wherein in a case where a change in the position registration area to which the host device belongs is detected based on the information acquired by the area information acquisition unit, the control unit is configured to notify a terminal device connected to the host device of the change in the position registration area through the communication unit.

(8) To solve the above-described problem, a vehicle according to one aspect of the present invention include: the base station device according to the above-described section (3).

(9) To solve the above-described problem, a terminal device according to one aspect of the present invention includes: a reception unit configured to receive information based on a change in a position registration area to which a host device belongs from a base station device connected to the host device; and a request unit configured to request association of information for specifying a position registration area after change with information for specifying the host device based on the information received by the reception unit.

(10) To solve the above-described problem, a communication method, according to one aspect of the present invention, in a moving object communication system includes a terminal device and a base station device, the communication method including: detecting a position registration area to which the base station device belongs; and associating, in a case where a change in the position registration area to which the base station device belongs is detected, information for specifying a position registration area after change with information for specifying a terminal device connected to the base station device.

(11) To solve the above-described problem, a communication method, according to one aspect of the present invention, of a base station device in a moving object communication system includes a terminal device and a base station device, the communication method including: acquiring information relating to a position registration area to which a host device belongs; and transmitting, in a case where a change in the position registration area to which the host device belongs is detected based on the information, a request for associating a terminal device connected to the host device with a position registration area after change to a base station control device corresponding to the position registration area after change.

(12) To solve the above-described problem, a communication method, according to one aspect of the present invention, of a base station device in a moving object communication system includes a terminal device and a base station device, the communication method including: acquiring information relating to a position registration area to which a host device belongs; and notifying, in a case where a change in the position registration area to which the host device belongs is detected based on the information, a terminal device connected to the host device of the change in the position registration area.

(13) To solve the above-described problem, a non-transitory computer readable recording medium, according to one aspect of the present invention, stores a program causing a computer of a base station device in a moving object communication system including a terminal device and a base station device to: acquire information relating to a position registration area to which a host device belongs; and transmit, in a case where a change in the position registration area to which the host device belongs is detected based on the information, a request for associating a terminal device connected to the host device with a position registration area after change to a base station control device corresponding to the position registration area after change.

(14) To solve the above-described problem, a non-transitory computer readable recording medium, according to one aspect of the present invention, stores a program causing a computer of a base station device in a moving object communication system including a terminal device and a base station device to: acquire information relating to a position registration area to which a host device belongs; and notify, in a case where a change in the position registration area to which the host device belongs is detected based on the information, a terminal device connected to the host device of the change in the position registration area.

(15) To solve the above-described problem, a non-transitory computer readable recording medium, according to one aspect of the present invention, stores a program causing a computer of a terminal device in a moving object communication system including a terminal device and a base station device to: receive infonnation based on a change in a position registration area to which a host device belongs from a base station device connected to the host device; and request association of information for specifying a position registration area after change with information for specifying the host device based on the information received.

According to an aspect of the present invention, it is possible to shorten a period in which position registration areas are different from each other in a case where a base station device and a terminal device move across the position registration areas.

### BRIEF DESCRIPTION OF THE DRAWINGS

FIG. 1 is a block diagram illustrating a configuration example of a moving object communication system of an embodiment.

FIG. 2 is a block diagram illustrating a configuration example of a terminal device.

FIG. 3 is a block diagram illustrating a configuration example of a base station device.

FIG. 4 is a block diagram illustrating a configuration example of a base station control device and a management device.

FIG. 5 is a diagram illustrating an example of a relationship between the base station device, a position registration area, and a base station control device.

FIG. 6 is a diagram illustrating an example of a database.

FIG. 7 is a diagram illustrating an example of a status in which the base station device moves across the position registration area.

FIG. 8 is a diagram illustrating an example of a database.

FIG. 9 is a diagram illustrating an example of a sequence in the moving object communication system.

FIG. 10 is a diagram illustrating another example of the sequence in the moving object communication system.

FIG. 11 is a block diagram illustrating another example of the base station device.

FIG. 12 is a diagram illustrating another example of the sequence in the moving object communication system.

FIG. 13 is a block diagram illustrating a modification example.

### DETAILED DESCRIPTION OF THE INVENTION

Hereinafter, a moving object communication system, a base station device, a vehicle, a terminal device, a communication method, and a program to which the present invention is applied will be described with reference to the accompanying drawings.

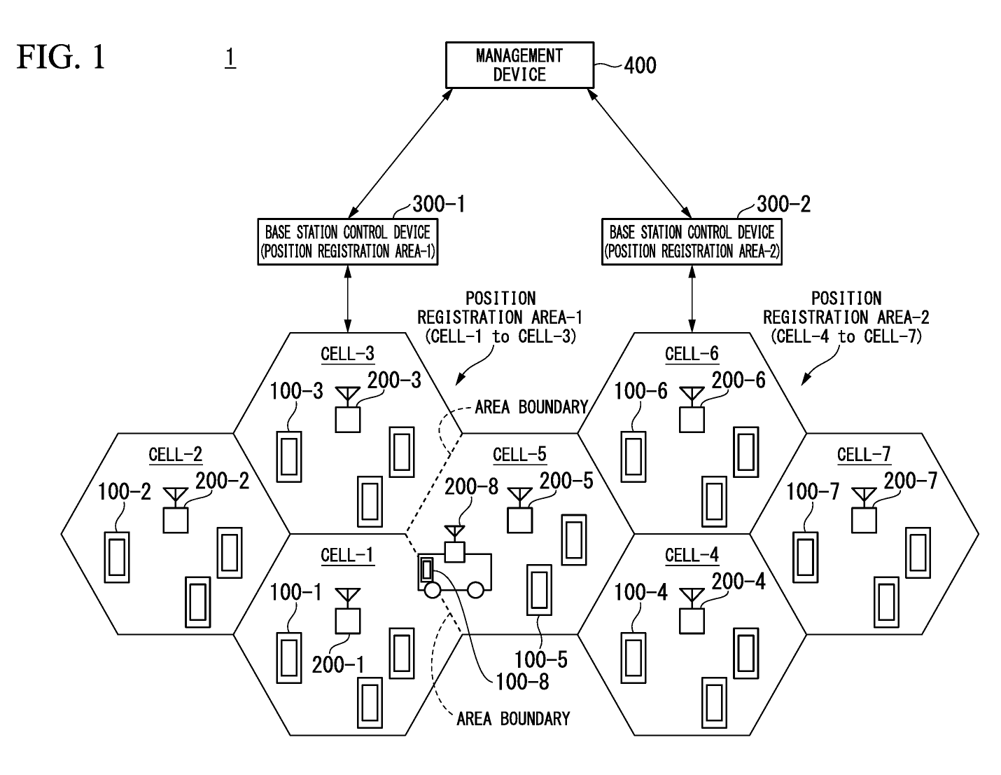

FIG. 1 is a block diagram illustrating a configuration example of a moving object communication system 1 of an embodiment. The mobile communication system 1 includes, for example, a plurality of terminal devices 100-1 to 100-8, a plurality of base station devices 200-1 to 200-8, a plurality of base station control devices 300-1 and 300-2, and a management device 400. The plurality of base station devices 200-1 to 200-7 are base station devices that do not move. The base station device 200-8 is a base station device that moves across a position registration area.

The base station device 200-8 is a base station device mounted on a vehicle such as, for example, a train. The base station device 200-8 moves while maintaining a predetermined positional relationship with the terminal device 100 which is possessed by a crew member in a vehicle. The predetermined positional relationship refers to a positional relationship between the base station device 200 and the terminal device 100 in a state where the terminal device 100 which is possessed by a crew member in a vehicle is taken aboard the vehicle. Meanwhile, in the following description, the vehicle is described to be a train, but there is no limitation thereto, and the vehicle may be, for example, a means of transportation, such as a bus, which moves with a crew member taken aboard.

Meanwhile, in the configuration example shown in FIG. 1, one management device 400 is shown, but a plurality of base station control devices 300 may be provided with one management device 400, and the management device 400 may be constituted by a plurality of devices. In the following description, in a case where a terminal device need not be distinguished from another terminal device, it is simply referred to as the “terminal device 100”, in a case where a base station device need not be distinguished from another base station device, it is simply referred to as the “base station device 200”, and in a case where a base station control device need not be distinguished from another base station control device, it is simply referred to as the “base station control device 300”.

The base station device 200, the base station control device 300, and the management device 400 form a moving object communication system. The base station device 200 is a base station device with a communication function such as, for example, Long Term Evolution (LTE) or LTE-Advanced, and the terminal device 100 is a mobile station device (user equipment (UE)) with a communication function such as Long Term Evolution (LTE) or LTE-Advanced. The base station control device 300 is, for example, a mobility management entity (MME). The management device 400 is, for example, a home subscriber server (HSS, or home location register (HLR)). Meanwhile, the MME and the HSS may be single devices, and may be systems including one or a plurality of devices serving as the MME and one or a plurality of devices serving as the HSS.

Each of the base station devices 200 forms a cell. The cell refers to a communication area formed by radio waves which are transmitted by the base station device 200. The communication area is also referred to as a coverage area or a coverage. The cell is also used to refer to the base station device itself that forms a cell or the frequency (also referred to as carrier or component carrier) of transmission radio waves.

A cell ID is given to each of the cells. The cell ID refers to an identifier (identification information) for identifying a cell. The cell ID is, for example, a physical cell identifier (PCI), an E-UTRAN cell global identifier (ECGI), an eNB identifier (eNB ID) or the like in LTE.

A cell-1 corresponding to the base station device 200-1, a cell-2 corresponding to the base station device 200-2, and a cell-3 corresponding to the base station device 200-3 form a position registration area-1.

A cell-4 corresponding to the base station device 200-4, a cell-5 corresponding to the base station device 200-5, a cell-6 corresponding to the base station device 200-6, and a cell-7 corresponding to the base station device 200-7 form a position registration area-2. A boundary line between the cell-1 and the cell-5 and a boundary line between the cell-3 and the cell-5 form a boundary line (area boundary) between the position registration area-1 and the position registration area-2. In FIG. 1, the area boundary is shown by a dotted line. The position registration area is an area into which a plurality of cells are grouped. The position registration area is equivalent to a range in which a paging process of the terminal device 100 is performed in a case where there is an incoming call (call connection request) to the terminal device 100. The position registration area-1 is equivalent to a range in which a paging process is executed by the base station control device 300-1. The position registration area-2 is equivalent to a range in which a paging process is executed by the base station control device 300-2.

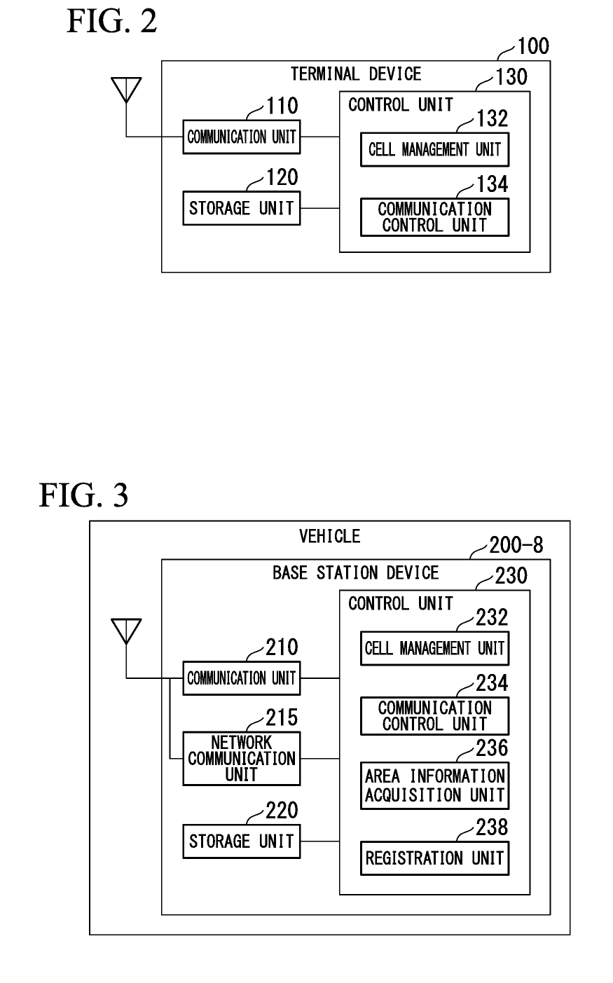

FIG. 2 is a block diagram illustrating a configuration example of the terminal device 100. The terminal device 100 includes, for example, a communication unit 110, a storage unit 120, and a control unit 130. The communication unit 110 includes a wireless communication interface for transmitting and receiving radio waves. The communication unit 110 transmits a transmission signal which is input from the control unit 130, as radio waves, to the base station device 200. The communication unit 110 receives the radio waves transmitted from the base station device 200 as a reception signal, and outputs the reception signal to the control unit 130.

The storage unit 120 is constituted by at least one hard disk drive (HDD), a flash memory, an electrically erasable programmable read only memory (EEPROM), a read only memory (ROM), a random access memory (RAM) or the like, or a combination thereof. The storage unit 120 stores various types of information relating to the terminal device 100 or programs.

The control unit 130 controls various functions of the terminal device 100. Some or all of the functions of the terminal device 100 may be realized by one or more processors such as, for example, a central processing unit (CPU) included in the control unit 130 executing various programs stored in the storage unit 120. The control unit 130 includes, for example, a cell management unit 132 and a communication control unit 134.

The cell management unit 132 manages the cell ID of a cell to which the terminal device 100 is connected. The cell management unit 132 acquires a cell ID which is transmitted by the base station device 200 as notification information using the communication unit 110, and stores the acquired cell ID using the storage unit 120.

The communication control unit 134 performs control relating to communication with the base station device 200. The communication control unit 134 performs communication connection to a base station device 200 corresponding to a cell ID based on the cell ID stored in the storage unit 120. Specifically, the communication control unit 134 performs, for example, establishment of connection with the base station device 200, disconnection therefrom, processing relating to handover, or control processing such as processing relating to transmission and reception of user data.

FIG. 3 is a block diagram illustrating a configuration example of the base station device 200-8. The base station device 200-8 includes, for example, a communication unit 210, a network communication unit 215, a storage unit 220, and a control unit 230.

The communication unit 210 includes a wireless communication interface for transmitting and receiving radio waves. The communication unit 210 transmits a transmission signal which is input from the control unit 230, as radio waves, to the terminal device 100.

The communication unit 210 receives the radio waves transmitted from the terminal device 100 as a reception signal, and outputs the reception signal to the control unit 230.

The network communication unit 215 includes a wireless communication interface for transmitting and receiving radio waves. The network communication unit 215 may share a communication interface with the communication unit 210, and may be a communication interface different from that of the communication unit 210. In addition, the network communication unit 215 may operate in accordance with the same communication protocol as that of the communication unit 210, and may operate in accordance with a communication protocol different therefrom. The network communication unit 215 communicates with a base station control device 300 that corresponds to a position registration area. That is, in a case where the position registration area of the base station device 200-8 has changed, the network communication unit 215 switches a communication partner from a base station control device 300 before change to a base station control device 300 after change. Meanwhile, the network communication unit 215 performs communication with the base station control device 300 using wireless connection, but there is no limitation thereto, and it may perform communication with the base station control device 300 using wired connection.

The storage unit 220 is constituted by at least one HDD, a flash memory, an EEPROM, a ROM, a RAM or the like, or a combination thereof. The storage unit 220 stores various types of information relating to the base station device 200-8 or programs.

The control unit 230 controls various functions of the base station device 200-8. Some or all of the functions of the base station device 200 may be realized by one or more processors such as, for example, a CPU included in the control unit 230 executing various programs stored in the storage unit 220. The control unit 230 includes, for example, a cell management unit 232, a communication control unit 234, an area information acquisition unit 236, and a registration unit 238. Meanwhile, the base station devices 200-1 to 200-7 that do not move are different from the base station device 200-8, in that these base station devices do not include the area information acquisition unit 236 and the registration unit 238.

The cell management unit 232 manages a cell ID which is set in the base station device 200-8. The communication control unit 234 performs control relating to communication with the terminal device 100 within the coverage area of the base station device 200-8. Specifically, the communication control unit 234 performs establishment of connection with the terminal device 100, disconnection therefrom, processing relating to handover, or control processing such as processing relating to transmission and reception of user data. In addition, the communication control unit 234 transmits the cell ID of the base station device 200-8 to the terminal device 100 with the cell ID included in notification information.

The area information acquisition unit 236 acquires information relating to a position registration area to which a host device belongs.

The area information acquisition unit 236 is, for example, a global positioning system (GPS) receiver (not shown) included in the base station device 200. The control unit 230 detects a position registration area to which the base station device 200-8 belongs based on the acquired information. The area information acquisition unit 236 detects, for example, position information of the base station device 200-8. The control unit 230 detects a position registration area corresponding to the current position of the base station device 200-8 by comparing the position information detected by the area information acquisition unit 236 with the position information of a position registration area stored in the storage unit 220 in advance. Meanwhile, insofar as information relating to a position registration area to which the base station device 200-2 belongs is acquired, the area information acquisition unit 236 may be an interface between devices such as the communication unit 210 that accepts a notification from another device or a universal serial bus (USB) which is not shown.

The area information acquisition unit 236 may specify the position of a train based on information from an operation management system of a train, and the control unit 230 may detect a position registration area based on the specified position. The operation management system of a train is a system that manages the operation status (such as the position or route) of a train based on, for example, a plan diagram. The area information acquisition unit 236 may acquire information indicating a current time, and the control unit 230 may detect the position registration area of the base station device 200-8 based on the current time. In this case, the control unit 230 may associate time information in the operation diagram of a vehicle having the base station device 200-8 mounted thereon with a position registration area, and detect the position registration area by comparing the current time with the time information.

The registration unit 238 performs a registration process in a case where a position registration area detected by the control unit 230 has changed. The registration process is a process for associating information for specifying a terminal device 100 with information for specifying a position registration area after change. The information for specifying a position registration area is, for example, an area ID, and the information for specifying a terminal device 100 is, for example, a terminal ID. Specifically, the registration unit 238 transmits information indicating the base station device 200 and the position registration area of a cell in which the terminal device 100 is located, as position registration information, to the base station control device 300 through the network communication unit 215.

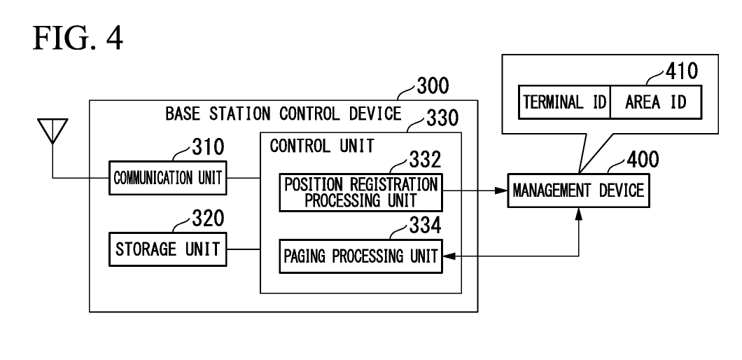

FIG. 4 is a block diagram illustrating a configuration example of the base station control device 300 and the management device 400. The base station control device 300 includes, for example, a communication unit 310, a storage unit 320, and a control unit 330.

The communication unit 310 includes a wireless communication interface for transmitting and receiving radio waves. The communication unit 210 transmits a transmission signal which is input from the control unit 330, as radio waves, to the base station device 200. The communication unit 310 receives the radio waves transmitted from the base station device 200 as a reception signal, and outputs the reception signal to the control unit 330. Meanwhile, the communication unit 310 performs communication with the base station device 200 using wireless connection, but there is no limitation thereto, and it may perform communication with the base station device 200 using wired connection.

The storage unit 320 is constituted by at least one HDD, a flash memory, an EEPROM, a ROM, a RAM or the like, or a combination thereof. The storage unit 320 stores various types of information relating to the base station control device 300 or programs.

The control unit 330 controls various functions of the base station control device 300. Some or all of the functions of the base station control device 300 may be realized by one or more processors such as, for example, a CPU included in the control unit 330 executing various programs stored in the storage unit 320. The control unit 330 includes, for example, a position registration processing unit 332 and a paging processing unit 334.

The management device 400 is, for example, a storage function mounted in an HSS. The position registration processing unit 332 performs a position registration process on the terminal device 100 using information received from the base station device 200. Specifically, the position registration processing unit 332 stores position registration information in the management device 400. Meanwhile, the position registration processing unit 332 causes the management device 400 to store an area ID in association with a terminal ID, but there is no limitation thereto, and it may cause the management device 400 to store a cell ID and an area ID to which the terminal device 100 belongs in association with a terminal ID.

In a case where the base station device 200-8 moves across a position registration area, the management device 400 associates a terminal ID with an area ID after change based on position registration information received from the base station control device 300. Thereby, the management device 400 constructs a database 410 in which a terminal ID and an area ID are associated with each other. Meanwhile, in the database 410, the cell ID of the base station device 200 to which the terminal device 100 is connected may be associated with a terminal ID in addition to an area ID.

In the paging processing unit 334, paging is requested from the information storage device 400 in a case where the base station control device 300 corresponds to a position registration area to which the terminal device 100 belongs at the time of the generation of downlink data such as an incoming call to the terminal device 100. The paging processing unit 334 simultaneously transmits paging signals to the base station devices 200 located down the base station control device 300 in accordance with the acceptance of a request.

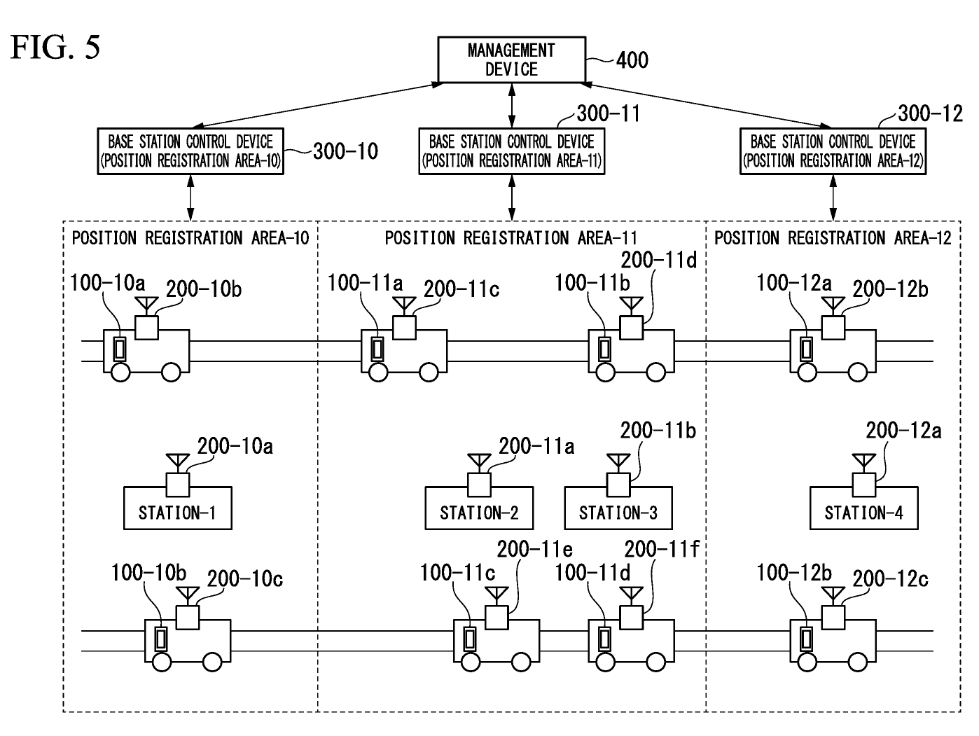

FIG. 5 is a diagram illustrating an example of a relationship between a base station device, a position registration area, and a base station control device 300. The moving object communication system 1 includes a base station control device 300-10 corresponding to a position registration area-10, a base station control device 300-11 corresponding to a position registration area-11, and a base station control device 300-12 corresponding to a position registration area-12.

A base station device 200-10a installed at a station-1 and base station devices 200-10b and 200-10c mounted on trains are present in the position registration area-10. A crew member who possesses a terminal device 100-10a is aboard a train on which the base station device 200-10b is mounted, and a crew member who possesses a terminal device 100-10b is aboard a train on which the base station device 200-10c is mounted.

A base station device 200-11a installed at a station-2, a base station device 200-11b installed at a station-3, and base station devices 200-11c to 200-11f mounted on trains are present in the position registration area-11. A crew member who possesses a terminal device 100-11a is aboard a train on which the base station device 200-11c is mounted, a crew member who possesses a terminal device 100-11b is aboard a train on which the base station device 200-11d is mounted, a crew member who possesses a terminal device 100-11c is aboard a train on which the base station device 200-11e is mounted, and a crew member who possesses a terminal device 100-11d is aboard a train on which the base station device 200-11f is mounted.

A base station device 200-12a installed at a station-4 and base station devices 200-12b and 200-12c mounted on trains are present in the position registration area-12. A crew member who possesses a terminal device 100-12a is aboard a train on which the base station device 200-12b is mounted, and a crew member who possesses a terminal device 100-12b is aboard a train on which the base station device 200-12c is mounted.

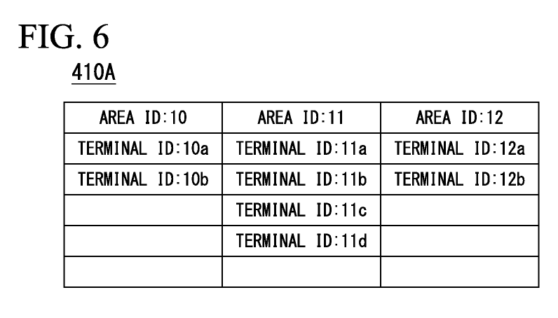

FIG. 6 is a diagram illustrating an example of a database 410A. In a case where the base station device 200 and the terminal device 100 belong to a position registration area as shown in FIG. 5, the management device 400 stores the database 410A as shown in FIG. 6. In the database 410A, the terminal ID=10a of the terminal device 100-10a and the terminal ID=10b of the terminal device 100-10b are associated with the area ID=10 of the position registration area-10. The terminal ID=11a of the terminal device 100-11a, the terminal ID=11b of the terminal device 100-11b, the terminal ID=11c of the terminal device 100-11c, and the terminal ID=10d of the terminal device 100-10d are associated with the area ID=11 of the position registration area-11. The terminal ID=12a of the terminal device 100-12a and the terminal ID=12b of the terminal device 100-12b are associated with the area ID=12 of the position registration area-12.

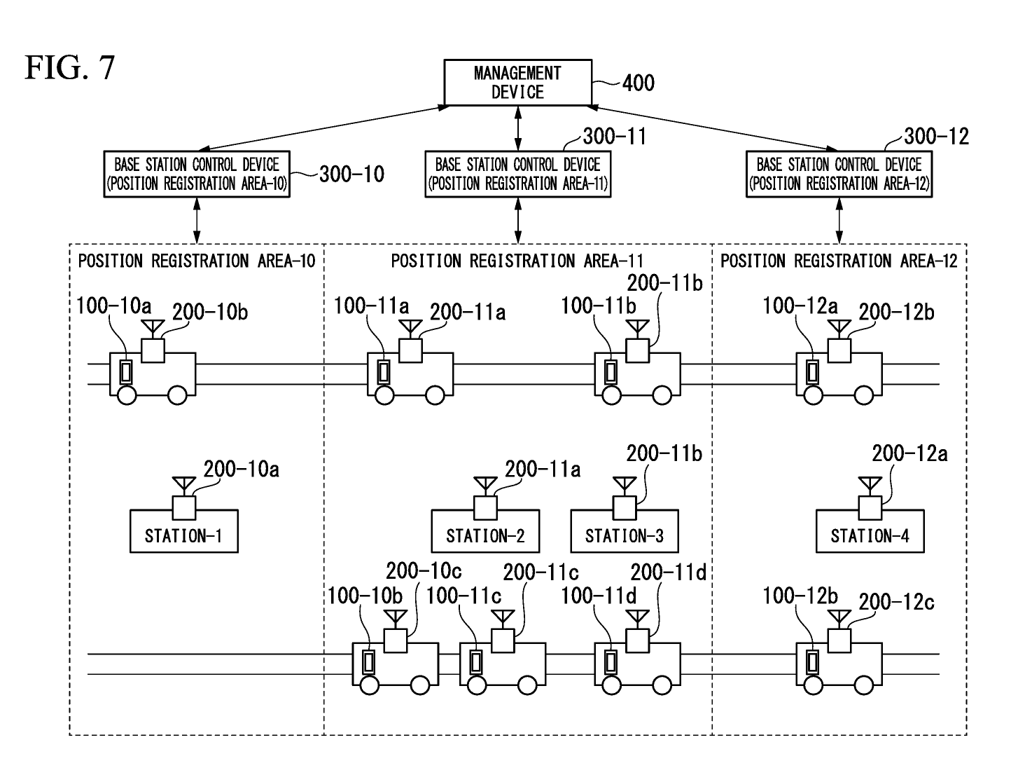

FIG. 7 is a diagram illustrating an example of a status in which the base station device moves across the position registration area. A vehicle having the base station device 200-10c mounted thereon is assumed to have moved from the position registration area-10 to the position registration area-11. In this case, the management device 400 changes the area ID of the position registration area corresponding to the terminal ID of the terminal device 100-10b to the area ID of a position registration area after movement.

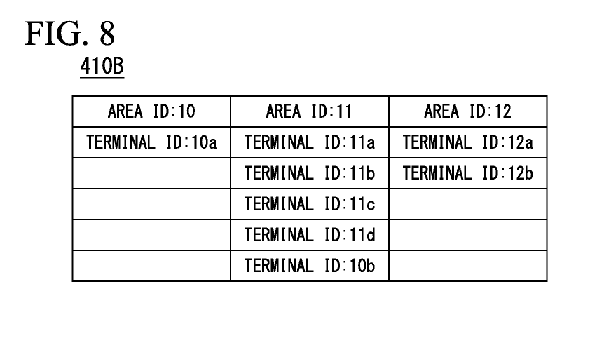

FIG. 8 is a diagram illustrating an example of a database 410B. In a case where the vehicle having the base station device 200-10c mounted thereon has moved from the position registration area-10 to the position registration area-11 as shown in FIG. 7, the management device 400 updates the database 410A to the database 410B. Specifically, the management device 400 associates the terminal ID=10c with the area ID=11, and erases the terminal ID=10c associated with the area ID=10.

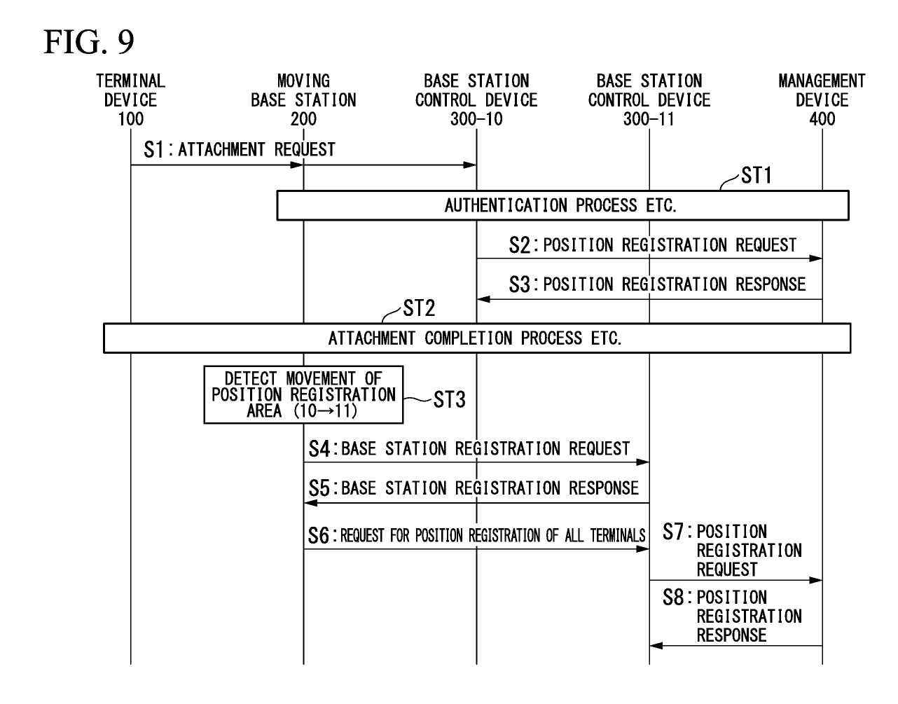

Hereinafter, a position registration process of the terminal device 100 in the moving object communication system 1 will be described. FIG. 9 is a diagram illustrating an example of a sequence in the moving object communication system 1. Meanwhile, in the following description, the base station device 200 is assumed to be a base station device that moves, and the terminal device 100 is assumed to be possessed by a crew member of a vehicle. For example, in a case where the power supply of the terminal device 100 is turned on, the terminal device 100 performs a cell search, and transmits an attachment request (S1) to the base station device 200 of a cell detected by the cell search. The attachment request may be replaced by a position registration request. The attachment request is transmitted to the base station control device 300-10 through the base station device 200.

The base station control device 300-10 performs a user authentication process, a data concealment process or the like (step ST1). Thereafter, the base station control device 300-10 transmits a position registration request (S2) including position registration information to the management device 400. The management device 400 associates the area ID of a position registration area to which the terminal device 100 belongs with the terminal ID of the terminal device 100 based on the position registration information. Thereafter, the management device 400 transmits a position registration response (S3) to the base station control device 300-10. Thereafter, the moving object communication system 1 performs an attachment completion process including the remaining process of the attachment process or the like (step ST2).

The base station device 200 is assumed to detect movement from the position registration area-10 to the position registration area-11 (step ST3). In this case, the base station device 200 transmits a base station registration request (S4) to the base station control device 300-11 which is a movement destination. The base station control device 300-11 associates the cell ID of the base station device 200 with the area ID of a position registration area in accordance with the base station registration request. The base station control device 300-11 transmits a base station registration response (S5) to the base station device 200.

The base station device 200 transmits a request (S6) for position registration of all the terminal devices 100 connected to the base station device 200 to the base station control device 300-11 through the network communication unit 215 in accordance with the reception of the base station registration response (S5). In this case, the base station device 200 includes the terminals ID of all the terminal devices 100 connected thereto in the position registration request. The position registration request (S6) is equivalent to a request for associating the terminal device 100 connected to the base station device 200 with a position registration area after change.

The base station control device 300-11 transmits a position registration request (S7) to the management device 400 in accordance with the reception of the position registration request (S6). The management device 400 associates the terminals ID of all the terminal devices 100 connected to the base station device 200 with the area ID of a position registration area after movement in accordance with the reception of the position registration request (S7). The management device 400 transmits a position registration response (S8) to the base station control device 300-11.

As described above, according to the moving object communication system 1, the position registration process for the terminal device 100 can be completed based on the request (S6) for position registration of all the terminal devices 100 transmitted from the base station device 200 to the base station control device 300-11.

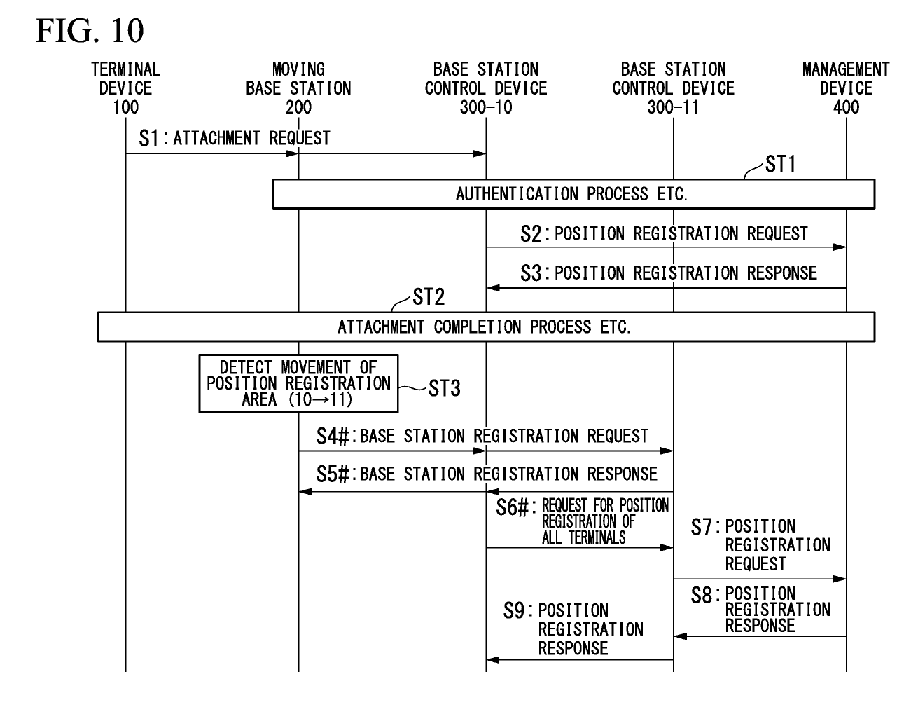

FIG. 10 is a diagram illustrating another example of the sequence in the moving object communication system 1. The moving object communication system 1 may complete the position registration process for the terminal device 100 based on a position registration request from a base station control device 300 which is a movement source to a base station control device 300 which is a movement destination.

In a case where movement from the position registration area-10 to the position registration area-11 has been detected (step ST3), the base station device 200 transmits a base station registration request (S4#) to the base station control device 300-10 which is a movement source. The base station device 200 includes the terminals ID of all the terminal devices 100 connected thereto in the base station registration request (S4#). The base station control device 300-10 which is a movement source transmits the base station registration request (S4#) to the base station control device 300-11 which is a movement destination. Meanwhile, the base station device 200 may transmit the base station registration request (S4#) to the base station control device 300-10 which is a movement source and the base station control device 300-11 which is a movement destination. The base station control device 300-11 associates the cell ID of the base station device 200 with the area ID of a position registration area in accordance with the base station registration request. The base station control device 300-11 transmits a base station registration response (S5#) to the base station control device 300-10 which is a movement source and the base station device 200. Meanwhile, the base station control device 300-11 which is a movement destination may transmit the base station registration response (S5#) to the base station control device 300-10 which is a movement source and the base station device 200.

The base station control device 300-10 which is a movement source transmits a request (S6#) for position registration of all the terminal devices 100 connected to the base station device 200 to the base station control device 300-11 in accordance with the reception of the base station registration response (S5#).

The base station control device 300-11 transmits a position registration request (S7) to the management device 400 in accordance with the reception of the position registration request (S6#). The management device 400 associates the terminals ID of all the terminal devices 100 connected to the base station device 200 with the area ID of a position registration area after movement in accordance with the reception of the position registration request (S7). The management device 400 transmits a position registration response (S8) to the base station control device 300-11.

The base station control device 300-11 which is a movement destination transmits a position registration response (S9) to the base station control device 300-10 which is a movement source in accordance with the reception of the position registration response (S8). Thereby, the base station control device 300-10 which is a movement source can recognize that the position registration process has been completed with respect to all the terminal devices 100 connected to the base station device 200. Meanwhile, the management device 400 may not transmit the position registration response (S9).

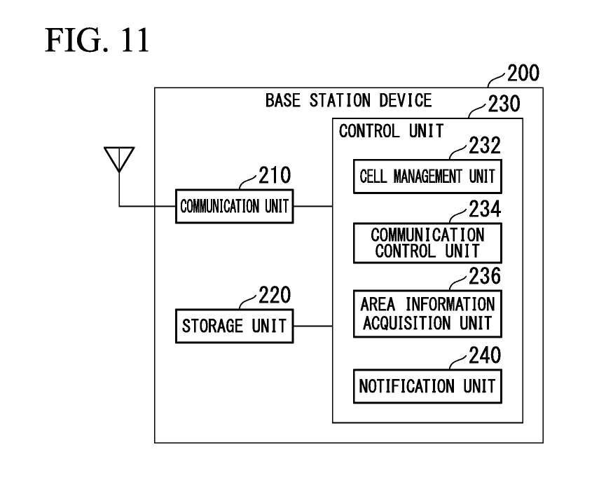

In the above-described sequence, the terminal device 100 is not notified that a position registration area has changed. The base station device 200 may notify the terminal device 100 that the base station device 200 has moved across the position registration area. FIG. 11 is a block diagram illustrating another example of the base station device. The base station device 200 includes a notification unit 240 instead of the registration unit 238.

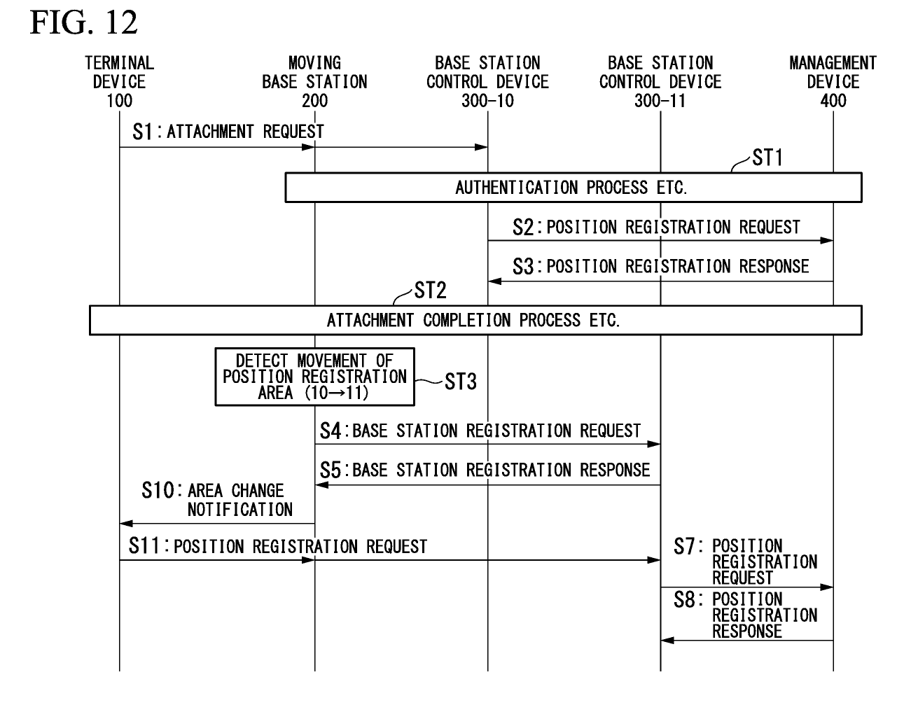

FIG. 12 is a diagram illustrating another example of the sequence in the moving object communication system 1.

In a case where movement from the position registration area-10 to the position registration area-11 has been detected (step ST3), the base station device 200 transmits the base station registration request (S4) to the base station control device 300-11 which is a movement destination, and receives the base station registration response (S5). The notification unit 240 of the base station device 200 transmits an area change notification (S10) to all the terminal devices 100 connected to the base station device 200 through the communication unit 210 in accordance with the reception of the base station registration response (S5).

The terminal device 100 transmits a position registration request (S11) to the base station device 200 in accordance with the reception of the area change notification (S10). The base station device 200 transmits the position registration request to the base station control device 300-11 which is a movement destination in accordance with the reception of the position registration request (S11).

The base station control device 300-11 transmits the position registration request (S7) to the management device 400 in accordance with the reception of the position registration request based on the position registration request (S11). The management device 400 associates the terminal ID of the terminal device 100 having transmitted the position registration request (S11) with the area ID of a position registration area after movement in accordance with the reception of the position registration request (S7). The management device 400 transmits the position registration response (S8) to the base station control device 300-11.

According to the moving object communication system 1 that executes such a sequence, in a case where the base station device 200 has moved across a position registration area, the terminal device 100 is notified of an area change notification, a processing load of the base station device 200 can be dispersed to the terminal device 100.

According to the moving object communication system 1 described above, in a case where a change in a position registration area to which the base station device 200 belongs has been detected, an area ID for specifying a position registration area after change can be associated with a terminal ID for specifying the terminal device 100 connected to the base station device 200. Thereby, according to the moving object communication system 1, in a case where the base station device 200 and the terminal device 100 have moved across position registration areas, it is possible to shorten a period in which the position registration areas are different from each other.

### MODIFICATION EXAMPLE

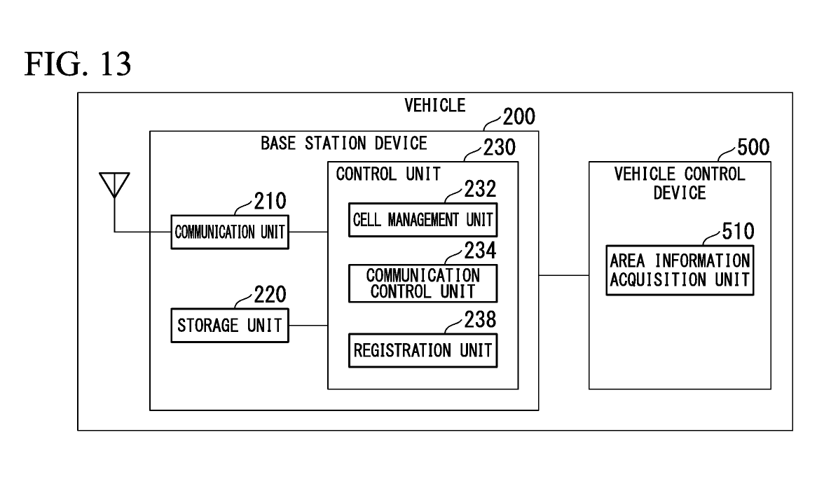

In the above-described embodiment, it is detected in the base station device 200 that the base station device 200 has moved across a position registration area, but there is no limitation thereto, and devices other than the base station device 200 may detect a change in a position registration area. FIG. 13 is a block diagram illustrating a modification example.

In the modification example, a vehicle control device 500 mounted in a vehicle includes an area information acquisition unit 510. The area information acquisition unit 510 specifies the current position of a vehicle based on, for example, position information of the vehicle received from the operation management system of the vehicle or information from a GPS. The vehicle control device 500 performs speed control or the like of a vehicle based on, for example, the position of the vehicle. The area information acquisition unit 510 compares position information of a position registration area which is set in advance with the current position of a vehicle to detect that the vehicle has moved across the position registration area.

Meanwhile, a program operating in the terminal device 100, the base station device 200, the base station control device 300, and the management device 400 in an aspect of the present invention may be a program (program causing a computer to function) for controlling, one or a plurality of processors such as a CPU so as to realize functions shown in each of the embodiments and modification examples relating to an aspect of the present invention. Information which is handled in each of these devices may be temporarily accumulated in a RAM during processing of the information, be stored in various storages such as a flash memory or an HDD thereafter, be read out by a CPU as necessary, and be corrected or written.

Meanwhile, some or all of the base station control devices 300 and the management devices 400 in each of the embodiments and modification examples described above may be realized by a computer including one or a plurality of processors. In that case, a program for realizing this control function may be recorded in a computer readable recording medium, and be realized by causing a computer system to read and execute the program recorded in this recording medium.

Meanwhile, the term “computer system” as used therein is a computer system built into the terminal device 100, the base station device 200, the base station control device 300, and the management device 400, and is assumed to include an OS or hardware such as peripheral devices. In addition, the term “computer readable recording medium” refers to a portable medium such as a flexible disk, a magneto-optic disc, a ROM, or a CD-ROM, and a storage device such as a hard disk built into the computer system.

Further, the “computer readable recording medium” may also include recording mediums that dynamically hold a program during a short period of time like networks such as the Internet or communication lines in a case that a program is transmitted through communication lines such as a telephone line, and recording mediums that hold a program for a certain period of time like a volatile memory inside a computer system serving as a server or a client in that case. In addition, the above-mentioned program may be a program which is used for realizing a portion of the aforementioned functions, and may be a program which is capable of realizing the aforementioned functions by a combination of programs previously recorded in the computer system.

In addition, some or all of each of the terminal device 100, the base station device 200, the base station control device 300, and the management device 400 in each of the embodiments and modification examples described above may be typically realized by an LSI such as an integrated circuit, and may be realized by a chip set. In addition, each functional block of the terminal device 100, the base station device 200, the base station control device 300, and the management device 400 in each of the embodiments and modification examples described above may be individually formed as a chip, and some or all of the functional blocks may be integrated and be formed as chips. In addition, a method of forming an integrated circuit may be realized using a dedicated circuit and/or a general-purpose processor without being limited to an LSI. In addition, in a case where an integrated circuit forming technique for replacement with an LSI appears with the development of semiconductor technology, it is also possible to use an integrated circuit formed using the technique.

Hereinbefore, each of the embodiments and modification examples has been described in detail as an aspect of this invention with the accompanying drawings, but specific configurations are not limited to each of the embodiments and modification examples, and also include a change in design and the like without departing from the scope of this invention. In addition, an aspect of the present invention can be changed variously in the scope shown in claims, and embodiments obtained by appropriately combining technical means disclosed in each different embodiment are also included in the technical scope of the present invention. In addition, configurations in which elements that are described in each of the embodiments and modification examples and exhibit the same effect are replaced with each other are included in the technical scope.

For example, an aspect of the present invention may be realized by combining some or all of the embodiments and modification examples.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Terminal device

200 Base station device

236 Area information acquisition unit

238 Registration unit

300 Base station control device

332 Position registration processing unit

400 Information storage device

410 Database

What is claimed is:

1. A moving object communication system comprising:
a terminal device;
a base station device;
an area detection unit configured to detect a position registration area to which the base station device belongs; and
a management unit configured to, in a case where the area detection unit detects a change in the position registration area to which the base station device belongs, associate information for specifying a position registration area after change with information for specifying a terminal device connected to the base station device.

2. The moving object communication system according to claim 1, the moving object communication system further comprising:
a control unit configured to request the management unit to associate information for specifying a position registration area after change with information for specifying a terminal device connected to the base station device in a case where a request based on the detection of a change in the position registration area to which the base station device belongs by the area detection unit is accepted.

3. A base station device comprising:
a communication unit configured to communicate with a terminal device;
an area information acquisition unit configured to acquire information relating to a position registration area to which a host device belongs;
a network communication unit configured to communicate with a base station control device that corresponds to the position registration area; and
a control unit,
wherein in a case where a change in the position registration area to which the host device belongs is detected based on the information acquired by the area information acquisition unit, the control unit is configured to transmit a request for associating a terminal device connected to the host device with a position registration area after change through the network communication unit.

4. The base station device according to claim 3,
wherein the control unit is configured to transmit the request to the base station control device corresponding to a position registration area after change.

5. The base station device according to claim 3,
wherein the control unit is configured to transmit the request to the base station control device corresponding to a position registration area before change.

6. The base station device according to claim 5,
wherein the control unit is configured to transmit a request for association of information for specifying a position registration area after change with information for specifying a terminal device connected to the host device from the base station control device corresponding to a position registration area before change to the base station control device corresponding to a position registration area after change.

7. A base station device comprising:
a communication unit configured to communicate with a terminal device;
an area information acquisition unit configured to acquire information relating to a position registration area to which a host device belongs; and
a control unit,
wherein in a case where a change in the position registration area to which the host device belongs is detected based on the information acquired by the area information acquisition unit, the control unit is configured to notify a terminal device connected to the host device of the change in the position registration area through the communication unit.

8. A vehicle comprising the base station device according to claim 3.

9. A terminal device comprising:
a reception unit configured to receive information based on a change in a position registration area to which a host device belongs from a base station device connected to the host device; and
a request unit configured to request association of information for specifying a position registration area after change with information for specifying the host device based on the information received by the reception unit.

10. A communication method in a moving object communication system including a terminal device and a base station device, the communication method comprising:
detecting a position registration area to which the base station device belongs; and
associating, in a case where a change in the position registration area to which the base station device belongs is detected, information for specifying a position registration area after change with information for specifying a terminal device connected to the base station device.
